(19) United States
(12) Patent Application Publication
(10) Pub. No.: US 2011/0070871 A1
(43) Pub. Date: Mar. 24, 2011

(54) Mobile Communications Facilitated by Interactive Menus

(76) Inventor: Ari KAHN, Mount Shasta, CA (US)

(21) Appl. No.: 12/917,255

(22) Filed: Nov. 1, 2010

Related U.S. Application Data
(63) Continuation of application No. PCT/US09/42602, filed on May 1, 2009.
(60) Provisional application No. 61/049,719, filed on May 1, 2008.

(51) Int. Cl. H04M 3/42

(52) U.S. Cl. 455/414.1

(57) ABSTRACT

Systems, methods, apparatus and computer program products related to mobile communications are disclosed. One method includes, responsive to a mobile originated teleservice request, pushing a contextual network initiated Unstructured Supplementary Services Data (USSD) session back to an originating mobile device including presenting a listing of a plurality of service options associated with a caller and/or the called party address information captured in the teleservice request.

### CROSS-REFERENCE TO RELATED APPLICATIONS

This application claims priority from and is a continuation of PCT/US09/42602, filed May 1, 2009, which in turn claims priority from U.S. Provisional Application 61/049,719, filed May 1, 2008.

### TECHNICAL FIELD

This disclosure relates to mobile communication techniques.

### BACKGROUND

Unstructured Supplementary Services Data (USSD) is an end-user signaling protocol and bearer that permits a mobile device to engage in an interactive dialog with an associated application on a network in near real time. In these dialogs a USSD “menu” can be provided to the user for selection of application options. Conventionally, the use of the term “menu” in this context is somewhat of a misnomer: USSD data, as the name encapsulates, is “unstructured.” The menu is simply a presentation construct, where the text payload is formatted and enumerated to appear as a structured and ordered list of options. To select an option the user simply replies to the USSD message with the associated letter/number/symbol, just as one would reply to a conventional text message.

Initially USSD (MAP Phase 1) was used to manage vertical network services (i.e., services that govern the behavior and characteristics of the mobile device on the home network). These USSD services were unidirectional and static, in that they were single transactions that transported requests from the handset to the servicing network application, and once acknowledged, then terminated. Moreover, users rarely encountered the USSD command codes, as these services were invoked via software menus on the phone.

Conventional early phase USSD services included industry standardized methods for setting mobile phone diverts, managing caller line identity presentation and restriction, and local flavors supporting prepaid services (e.g., balance checking and international callback services). USSD has since evolved into second generation services (MAP Phase 2) that can now support bidirectional, interactive sessions, permitting the mobile and the serving network application to engage in a near real time dialog.

Some conventional USSD implementations are being used in quasi peer-to-peer applications, however these are typically engaged using a static USSD service model, on manually entered codes. One conventional application is USSD “callme,” which spins a “call me back” text message to a destination mobile number included in the USSD command string.

While it is possible to engage a USSD session during an active telephony call, up to now these two transports, and their resultant connections, have lacked a shared context. That is, when initiating a USSD call on an active telephony call, the scope of the dialed destination address information that establishes the latter, is local to the call, and up to now, been inaccessible to the former.

While it is technically possible, on a suitably enabled network, to momentarily share the dialed context between a USSD and a regular telephony call, the methods that are invoked are applied “sequentially and vertically,” rather than “horizontally and in parallel” and thus still remain distinct “non intersecting” events. For example, the following “hybrid USSD/telephony” command both instructs the servicing switch to: (1) transiently apply Caller Line Identity Restriction while, (2) establishing a conventional telephony call to the specified address:

#30#+14154125111 send

Similarly, conventional methods for establishing a USSD call to invoke interactive services with the same party actively engaged on a telephony call, would require mental gymnastics and superior dexterity: the user would be required to manually switch context, command and redial. Notwithstanding the contortions, photographic memory is required, and this is, for all intents and purposes, simply impractical, as the following steps illustrate:

Step 1: address the telephony call and press send

Here the caller typically selects the contact from the recent calls log otherwise selects a name from a preprogrammed address book, and consequently, rarely enters the mobile phone number, once having previously established contact

Step 2: select “new call” menu option

This option becomes available when the first call is connected and requires soft key menu selections

Step 3: enter the USSD call command

Here the user has to recall the dialed party (i.e., from short term memory) and reenter the number adhering to the cryptic USSD syntax:

*121*4154125111# send

Thus, as is evident, a limitation to this core bearer service is the cryptic user engagement: USSD requires a complex “mash up” of star and hash codes, manually entered every time the service is required, since USSD commands are not recorded in the conventional call logs and thus cannot be recalled directly on a conventional mobile device. A typical USSD application service requires manually entering at minimum: a three digit service code followed by a 10 digit mobile phone number, with the appropriate star and hash delimiters as in:

*121*4154125111# send.

Notwithstanding the fact that many users frequently neglect to terminate the USSD command with a “hash” prior to sending (which results in an incorrectly dialed telephony call), a user has to enter a service code and has to recall the phone number from personal memory. So whereas mobile telephony calls can be established in just “two clicks” (Send, to recall recently dialed numbers, and Send again to connect to the selected contact) USSD painfully requires twenty or more clicks every time. Applications developed to shield users from complex codes, inadvertently suffer from another, yet related syndrome: multiple navigation steps to locate and launch. Consequently the user experience is still substandard. More problematic, since each USSD application requested from the handset requires a unique “operator code assigned” and given that these codes vary between operators, delivering a uniform method to make new services available in advance is challenging.

### SUMMARY

Methods, systems, apparatus and computer program products are provided for presenting a seamlessly addressed interactive menu of network services to an originating mobile device on a telephony network. In one implementation, a method is provided that includes leveraging USSD in a network initiated context, to present a virtual text browser to a given mobile device, on the fly, without requiring any change 30 to the mobile device and mass user behavior, while delivering a secure peer to peer signaling channel between caller and called.

Certain aspects of the invention may include one or more of the following features. Methods are proposed that engage USSD services directly on the regular subscriber telephone number, regardless of the dial entry point (e.g., call log, phonebook, SMS) and thereby deliver seamless service differentiation on the regular subscriber number without change. Methods disclosed enable a user to universally engage USSD in concert with regularly addressed teleservices, whereby the network now pushes the USSD connection back to the caller, rather than requiring the caller to explicitly request it from the mobile device. A dynamically invoked USSD session can be provided that uniquely delivers a virtual, ultra narrowband (e.g., text only) browser to all mobile devices, without change.

### DESCRIPTION OF DRAWINGS

FIG. 1a shows an example of a high level schematic representation of a communication environment including a delivery of dynamic menus at a telephony service initiation to a calling party.

FIG. 1b shows an alternate view of the communication environment with the core entity relationships

FIG. 2 shows an example of a service matrix.

FIG. 3 shows an example basic menu.

FIG. 4 shows an example menu switching.

FIG. 5 shows an example advanced application.

FIG. 6 shows an example of an emerging market development.

FIG. 7 shows an example of an emerging market interaction.

FIG. 8 shows an example of a universal remote control.

### DETAILED DESCRIPTION

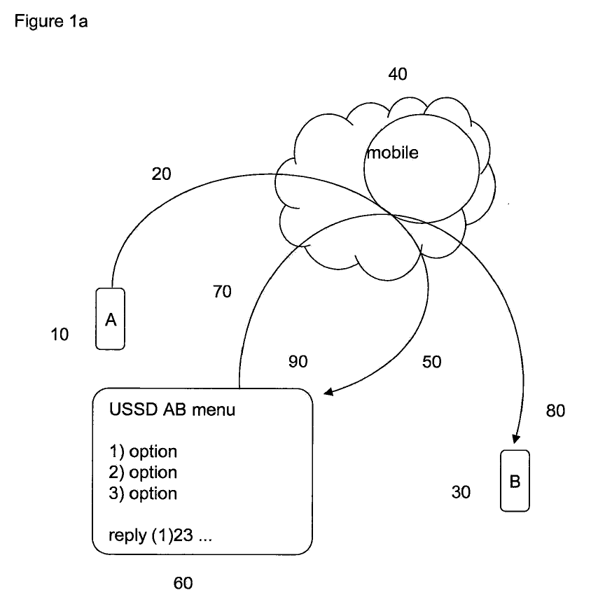

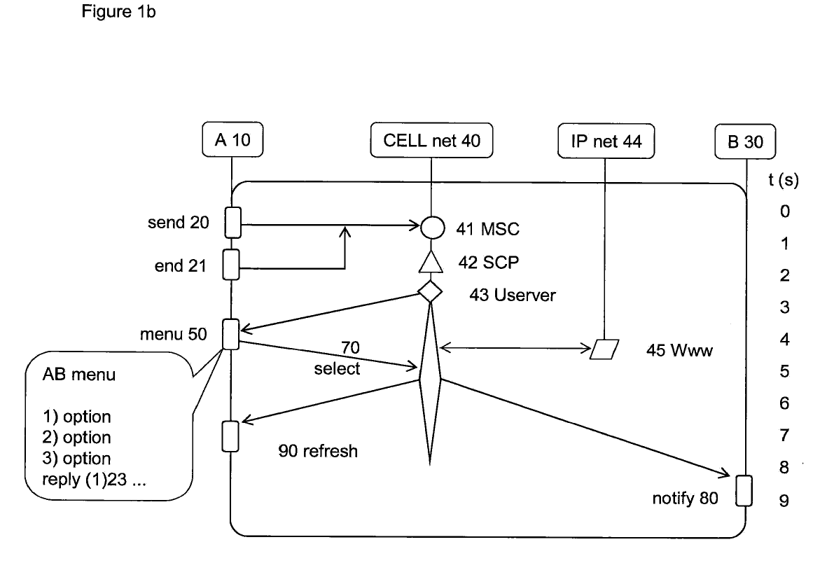

Referring now to FIG. 1a, an example mobile communication environment is shown that includes a plurality of mobile users (i.e., devices) 10 and 30 coupled by a mobile communication network (e.g., servicing mobile network 40). Servicing mobile network 40 includes a USSD application server (not shown) that hosts a USSO application (also not shown).

In operation, mobile user 10 requests a teleservice 20 (e.g., dials a number, sends an SMS, sends a ping) addressed to mobile user 30 and sends the request to the servicing mobile network 40. On receiving the request, and in concert with conventional switching and routing of the teleservice towards the destination mobile user 30, the servicing mobile network 40 spawns a USSD session 50, displayed in enlarged view, back to the originating mobile user 10, listing service options 60 automatically associated with one or both of mobile user 10 and 30. Caller (the “user” of mobile user 10) may at this stage choose to dismiss the menu, and in the case where the teleservice is a telephony call, may choose to terminate the active connection while retaining the menu. Alternatively, the service may elect to not complete the teleservice until user input is provided (e.g., such as in response to a menu item presented as part of the menu service).

On selecting a menu option 70, by replying to the USSD menu presented as part of the USSD session 50 with the associated enumerated character/number/symbol (in this illustration, the number preceding the option), the serving USSD application logically maps the selection to the displayed option and automatically invokes the selected service, for example service 80. The reply is equivalent to clicking a link and is logically mapped to the associated function on the server side (e.g., at the USSD application). As the menu is virtual (it does not reside on the receiving device) and scripted on the server side, it is consequently dynamic: any change in content applied at the servicing application (e.g., executing at the USSD application server or “Userver”) instantly propagates to the user on the next refresh 90.

Referring to FIG. 1b, an alternate view of the communication environment is shown that includes presentation of the core entity relationships and a typical timeline to the above events in seconds (at right). In this schematic, the Userver 43 (hosted on the Mobile Cellular Network 40) is shown interconnected to the Internet 44 (hosting a World Wide Web server 45) using conventional interfaces and protocols. In this view, the originating mobile 10, is shown disconnecting a telephony request 20, addressed to mobile 30, by signaling end during the call setup 21. This teleservice event is forwarded by the servicing MSC (Mobile Switching Center) 41 to a SCP (Service Control Point) 42, which then interfaces with the USSD platform 43, invoking the disclosed methods and presenting the menu 50. Interaction then proceeds as described above.

The method disclosed enables a peer-to-peer application development and distribution paradigm referred herein collectively as “star applets” or “starlets.” Starlets can be of the form of an applet hosted on Userver and presented in a “Star” branded menu. In some implementations, Starlets are extremely light weight applications with nano footprints, built on a ultra narrowband client-server architecture. In some implementations, Starlet application logic is massively centralized, in network clusters, presenting the user with highly distilled application tinctures, manifested, in simple enumerated lists of text. The Starlet applications can be laser focused in design. In some implementations, a Starlet application delivers one, two, and at most three features in their entirety, engaged with as few keystrokes, and screen refreshes, as possible.

Designing postage-stamp sized applications, for a text only “2 inch canvas,” presents unique challenges. The application storyboards, call for richly woven, highly contextual and distilled interfaces, where entire applications may be reduced to single words, and where literally every character and symbol presented to the user counts. The limiting real estate, the primitive interface and the narrowband nature of the delivery, collectively demand some exacting rules of engagement. Examples of these aspects are highlighted and addressed, in the following case studies.

In order to maximize the limited navigational control offered by USSO menus, in some implementations the interactive methods disclosed leverage the simplicity of accepting alphanumeric input as detailed below. In some implementations, implied selection may be achieved by setting default options and timing events on the Userver side. For example, if the user instantly dismisses an initially received menu on receipt, the application (e.g., the USSO application) can interpret this action as electing to exit the menu session without effect. However, if the user dismisses the session momentarily, after a brief pause, the Userver may automatically apply a default menu selection. Adding a time domain to user interaction, delivers controlled exposure to the new services presented, and allows two click access to repetitive functions by operating exclusively on the top level Send and End keys.

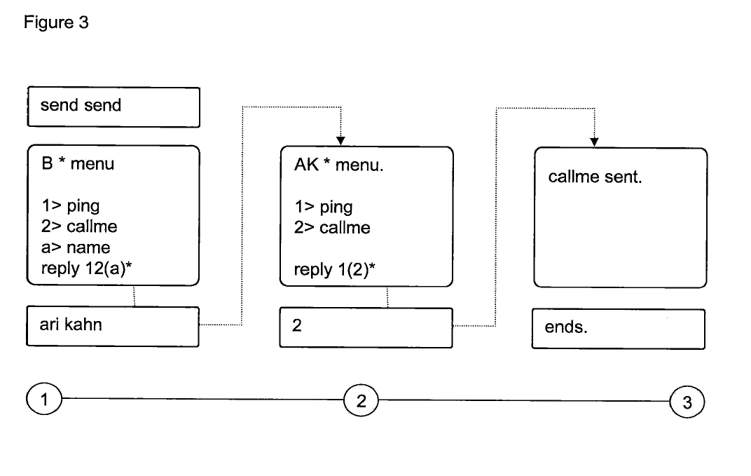

FIG. 3 illustrates an example of a basic menu presenting options to a caller whose teleservice request has been declined due to insufficient credit. In this example, the first menu screen (I) lists three options: the first two options requiring selection only, are enumerated by number, the third option, which is the default, parenthesized option, “(a)”, requiring additional input, is enumerated by letter. In this example, all the options apply to the dialed destination, as evidenced by the “>” forward directional indicators. That is, the “>” options are applied from A to B, where A is the source and B the destination numbers described in the teleservice request. The illustration assumes the user has previously established contact with the dialed destination, and the B number can thus be directly recalled from a recently dialed log.

The recently dialed log can be uniformly accessed, for example, by pressing the Send key once, when at the desktop (main screen) on the mobile phone. In this example, the user has scrolled to the required number and pressed Send a second time to connect. If the required number is the most recently dialed number, the user may then simply “double click the Send key” to request the telephony service, as depicted in the first step in FIG. 3, titled “Send Send.” In this example the user is automatically disconnected by the Network due to insufficient credit, and the USSD session is then established sequentially, following the teleservice request, thus presenting the menu “solo,” without an active call in the background. The time elapsed between requesting the teleservice and receiving the menu, is typically mere seconds.

Continuing with the example in FIG. 3, the user selects and replies to the default menu option, simply by entering the name of the called party (“ari kahn”) and pressing send. Alternatively, other ways of identifying the user are possible. For example, a default user name may be presented by the Userver that is associated with the mobile number of the calling party. Replying to a USSD message is effectively identical to replying to an SMS message. However, as the USSD connection is session based, the roundtrip between submitting the data and receiving a response from the Userver is negligible, and the next screen (2) displays almost instantly. On receiving the response to the first screen, the Userver receives the data, logically associates the text with the default option (“name”), returns a personalized screen view (2), titled, in this example, using the initials “AK.” Optionally, the Userver can store the name in a central database, to persist the association with the dialed number for future presentation.

Using initials to personalize the service, minimizes screen real estate and is sufficient to recognize a dialed number in the future. In some implementations, in the absence of personalization, the Userver presents both menu screens (1 and 2) by displaying the number (not shown). For the sake of simplicity, “A” and “B” are used as placeholders for the source and destination addresses throughout the examples herein. In some implementations, once personalized, the caller is then always greeted by presenting a name, rather than phone number titled menus. Options to edit the name (not shown) once entered, may be easily incorporated.

On receiving the name input, the Userver automatically reassigns the default option to the next most likely candidate, “callme” (option 2). This predictive interface, delivers minimum user interaction, and permits one to simply reply, for example, with an empty message to select the default option (on most handsets). Alternatively, the user simply replies and presses the corresponding numeric key. For example, pressing “2” would input the character “a.” This is because standard text editors on mobile phones are engaged in alpha mode. To enter the numeral 1, most devices commonly require the user to press and hold the key, which momentarily switches the context to numeric mode and inputs the digit.

This context switching can be a frustrating experience. On some phones, the user would be required, for example, to press the key several times to input the number, cycling through all the permutations, which in this instance would be “a b c 2.” On more recent models where predictive text is standard, numeric input behavior differs from model to model. In some implementations, the methods disclosed can accommodate for these differences by providing menu selection options that are not ambiguous (e.g., a menu option of “a” is interpreted if an “a” is received or a “2”). Menus and selection options can be constructed to eliminate the need by the user to scroll through numeric or alpha options for the limited key set. This allows the user to press the associated numeric key just once, and regardless of the input displayed, (in this instance any of the associated characters, a/b/c and even predictive combinations such as “cab” and “bac”) selecting the intended option, since the input is programmatically and intelligently, mapped back at the Userver to the unique corresponding selection.

In some implementations, if the default option in the list is “(a),” and the user replies with the single letter “b,” then, the selection would be interpreted as the user selecting option “2.” Conversely, if the default option in the list is “(2)” and the user replies with “a ari kahn,” then as there is more than a single character response to the message, the Userver would interpret the input as “option a,” name=“ari kahn”), rather than “callme” which would have been invoked if the response had been the single, character “a,” without the additional text. This is the same logic that permits a default, alphabetically enumerated option to be selected without having to enter the enumerating letter as the first character in the response.

When delivering high frequency services, repetitively engaged, an intelligent and frictionless interaction is essential, as every keystroke counts. Additionally, given the free format nature of the USSD reply, and the universal tagged nature to contact information, in some implementations, an option titled “personalize” can be presented in a menu, which upon selection could present a screen requesting multiple inputs in a single response, such as: “enter name, email, age and blog address.” Since all but one item is uniquely formatted, the application can resolve a string (e.g., an item with “@” as describing email that with “www” and/or “.com” (sans “@”) as the blog address, and a numeric entry as the age with any remaining consecutive words spelling the name). Large amounts of data may thus be aggregated and collected, in a soup like fashion.

The basic service described in FIG. 3, may logically and visually be extended to support additional features. However, in this example the objective is to deliver highly specific and simple to engage services, without clutter and without engaging the USSD “channel” longer than is required. In some implementations, when a selection is made, the Userver on returning the result, may automatically terminate the session, as depicted in the last screen (3), in FIG. 3, which is footnoted “ends.” Given the rudimentary interface, and the near instant access to the menu of services using the methods disclosed, it may be more efficient and effective to simply invoke a new session and access an earlier screen, than to offer forward and backward navigation while actively engaged on an existing session.

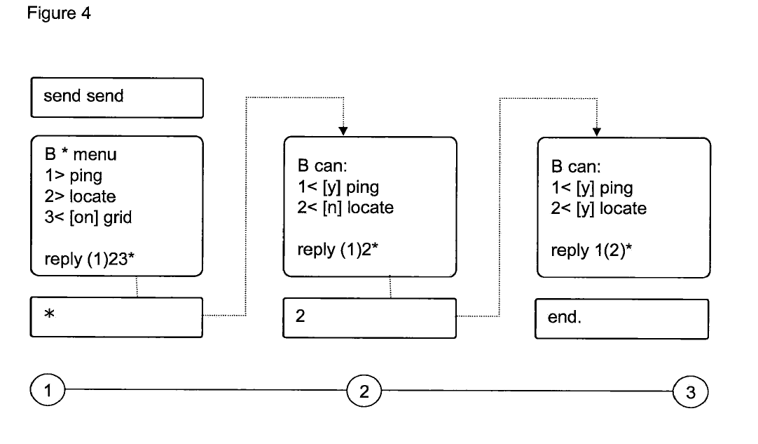

The peer nature of the services presented using the disclosed methods, calls for the ability to control how caller and called interact on a permissive basis. An example of this functionality is illustrated in FIG. 4, which shows an example of how switching the current view, from “A” to “B” can present instant access to such features. Screen 1, is an example incremental implementation of the basic service as described in FIG. 3 above, now incorporating a “search” function, in place of the “name” option, since the latter information already has been collected. On replying “*,” the Userver presents screen 2, displaying options that govern what related services the destination may engage, when they are presented with the reciprocal menu on requesting teleservice to the source (in this instance, the destination and source are then reversed).

In this example, screen 2 displays options to control whether the destination engaged has permission to ping and/or locate the source. In the example shown, replying to either option would then toggle selection of the associated service (Yes/No, On/Off). Since USSD menus are “static,” that is they cannot effectively be “disabled,” the Userver would then simply programmatically hide and show the associated options, dependant on whether permission was denied or granted. Screen 1, which presents both the options to the caller, as applied to the called, represents in one example the default view, as permissions are both initially positive.

In this example, we first assume that the Userver, associated with the mobile servicing network includes functionality or accesses functionality that provides location based services. The location based services can be used to locate a mobile device. In the above example, on screen (1) selecting option “<3” (directed towards the caller) would prevent any and all users from locating me (the originating device) toggling the option to reflect my new status (“[off] grid,” not shown), and effectively hiding my mobile device from the world. For example, the location based services application can store block code associated with the mobile identifier of the originating device. When disabled, other devices that attempt to locate the originating device will be prevented from accessing the location based function.

Replying with “*,” switches the menu view as described above, presenting screen (2) and selecting option “2” would similarly toggle permission for the destination device to locate me, as reflected in screen (3). Note, that by making option “2>locate” available to me in screen (1), implies the destination device, has similarly, permitted me to track it. These peer-to-peer bindings can be stored in a central database so they can persist between USSD sessions. Before presenting the menu shown, the serving USSD application can query the database to determine the location based switches in effect between the source and destination devices and assemble the menu items accordingly (dynamically inserting and removing options as required).

If the destination device has not blocked location based services and has permitted the calling mobile device to locate them, as reflected in screen (1), option “2,” then on selecting “2,” the servicing USSD application (in association with the location based application) could return location information, for example, in text form first, with more graphic options downloaded, that could pinpoint the location on a map.

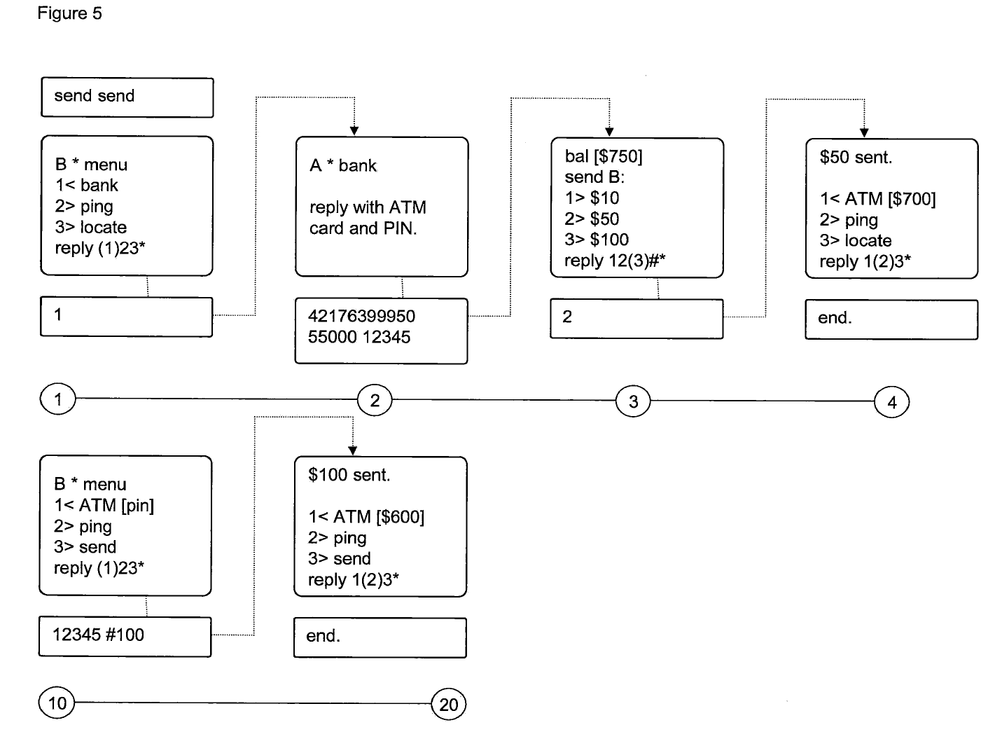

As basic as these services may appear, in some implementations the real power and sophistication to the methods disclosed vests in the fact that all the application logic resides centrally, in the Userver, and consequently executes remotely, without requiring any specific device capability. As the Userver is capable of interconnecting with other ecosystems (not shown), such as banking in this instance, all the complexities behind a simple text menu, are abstracted from view, and relegated to the back office. While the challenges around viewing and communicating with new galaxies (i.e., other systems), through a “nanoscope” are evident, the Advanced Telephony Menu (ATM) application depicted in FIG. 5, illustrates how engaging the view can get, and how extensible and adaptive the disclosed system is.

Referring to FIG. 5, screen (1) presents an alternate example to the initial menu presented on requesting a telephony call. While the additional banking functionality is evident, the following comments serve to highlight the salient aspects. The example presents an initial caller experience (i.e., a caller that has not experienced the methods or resultant menus previously). The default option labeled “<bank,” further indicates that this service is directed back towards the caller (as in “my bank”) On selection, the user is prompted to enter a bank ATM card together with the ATM pin. Once captured, this information can be stored persistently by the Userver in, for example, a central database, so it maybe accessed and referenced in future sessions.

The next screen (2) in the sequence depicted, presents the current balance associated with the ATM card (i.e., the account associated with the ATM card), together with an enumerated list of transfer denominations. In some implementations, the denominations may be intelligently constructed with reference to the current balance, and/or past transfers, and may also automatically present currency conversion on the destination address (e.g., the ability to present common denominations as menu options significantly reduces user input error). The card bank balance information can be obtained directly by the Userver, for example, on requesting the account information using standard bank switched interfaces and protocols (not shown). The user may then, with a single additional key press, transfer a required amount to the destination address specified in the telephony call.

On selecting the amount to be transferred (“2”), the USSD serving application would broker a financial transaction, debiting the account associated with originating mobile user (e.g., mobile user 10) and crediting the account associated with called mobile user (e.g., mobile user 30). If called mobile user has no bank account set up, the serving application can automatically create a virtual wallet set, for example, to the mobile telephone number associated with the called mobile user (e.g., mobile user 30). The servicing USSD application could then appropriately notify the recipient mobile user (e.g., mobile user 30), for example by sending an SMS (“u have $100 starbux”), together with instruction how to redeem. In some implementations, substantially simultaneously, the USSD servicing application updates the screen (3) to reflect the transaction.

The additional screens (10 and 20) illustrate the menu presented to the caller on the next USSD session invoked. As the banking details have already been recorded, the first option now simply requests a PIN code to login to the banking service. In some implementations, it is as simple to request “login and transfer,” in a single step, by manually entering an amount in addition to the PIN, as indicated (using the “#” character to demark Pin and Amount). While this step is a degree more “advanced,” and precedes balance display, it is a compelling shortcut for power users doing frequent low value payments. Thus, typically, the ATM transaction is completed, on the fly, in just two clicks. This deceptively simple application delivers a massively compelling advanced mobile function.

In this example, the caller may now, for the first time, disclose the highly confidential Bank ATM PIN code seamlessly, directly and with complete confidence and security, using the cellular keypad to input the secret code into a screen that seamlessly presents to the caller account information, in concert with a telephony call just requested. As the code is control channel signaled, transmitted without generating DTMF tones, and without leaving any persistent record on the device itself, the ATM method disclosed is forensically undetectable, and delivers the first virtual and viable alternative to the analog namesake machine.

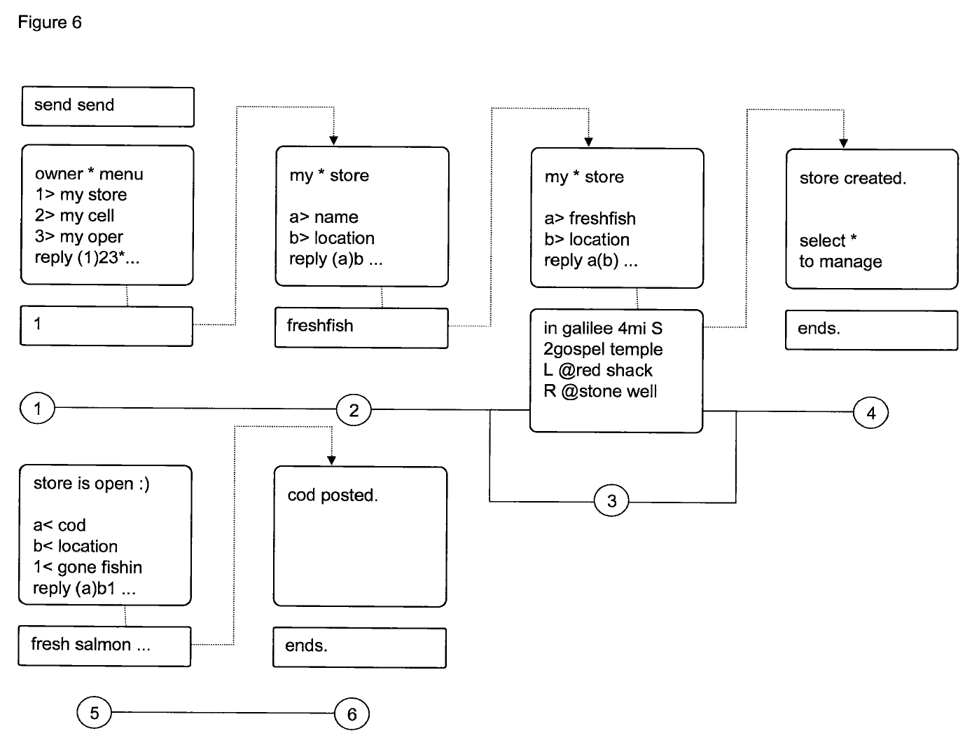

In the emerging mass markets, mobile commerce can be an extremely effective economic stimulus. The most basic interactive service, can be the determinant factor between going hungry and being fed. To illustrate the applicability of the some of the methods disclosed, and referencing FIG. 6, a simple virtual marketplace may be established, permitting a vendor, in this instance, a fisherman in a remote village to record the “catch of the day” by uploading his “inventory” for immediate access to all, in real time. The fisherman can request a revertive interactive teleservice by, for example, dialing his own phone number to invoke the USSD menu session, which is then instantly pushed back to his phone, enabling him to setup shop.

With reference to FIG. 6, it is assumed that the caller selects their own phone number from the recently dialed list. Dialing oneself is one example of an effective method for delivering personalization and owner services using the methods disclosed and is known in the industry as “revertive addressing,” where the originating mobile user (e.g., mobile user 10) and destination mobile user (e.g., mobile user 30) are one and the same. Revertive addressing applies to both telephony and SMS requests (the latter permits, for example, sending an empty message to oneself to invoke the method disclosed). This provides a direct entry point to USSD options that then relate to the originating device alone, and that would otherwise require an additional navigational step, as in selecting “owner services” from an initial USSD screen established on a regular teleservice, where the source and destination are distinct.

The initial screen (1), in FIG. 6, displays three options. Options “2 and 3,” are for illustrative purposes, and would present services related to the cell phone (name etc), and the home operator (airtime replenishment etc), both not shown. The first option “1,” delivers a virtual trading store, and is explained in more detail. This fisherman, in this example, has previously personalized his name, as reflected in the initials “AK.” Selecting the option, the owner is stepped through a micro setup wizard, capturing store name, and current location (responses truncated).

The ability to manually set current location in real time, permits the cell to perform analog location updates, where the user discloses actual location, rather than the network having to determine it. In rural areas, where network “triangulation” may yield coarse results, and more pragmatically the absence of either network or device capability, this simple service is remarkably sufficient. On completing the two step wizard, the connection ends. Dialing again and selecting “1<my store” a second time (or alternatively responding with “*” as shortcut), presents screen (5) and permits the owner to manage the store as shown. Selecting “a” (catch of day) and entering the following text, the fisherman posts a mobile, virtual billboard: “fresh salmon. 6pds.” The owner may post updates as inventory changes during the day.

The serving USSD application can be programmed to overwrite any previous submission, time stamp the current entry and record it for persistent viewing. On submitting the above text, in some implementations the USSD screen refreshes to display a preview. The same screen (5), would permit the owner to edit current location (option “b”) and virtually close the store (option 2). The current store status, open/closed may be reflected to a caller viewing the store, simply by, for example, displaying “happy and unhappy” emoticons, indicating at a glance the prospect of trading.

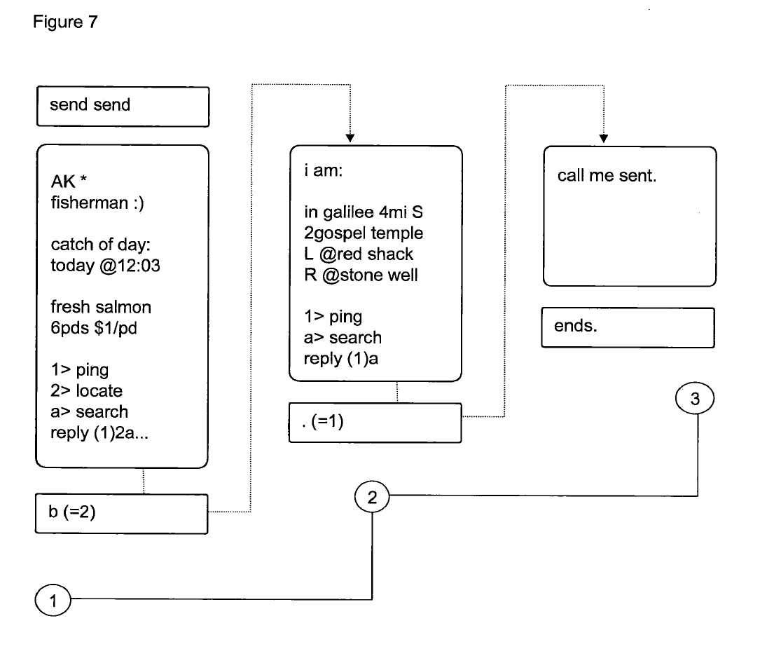

When another mobile device calls the fisherman, and engages the disclosed interactive USSD menu (e.g., even when calling without airtime credit available), the virtual store information uploaded as described above, can be instantly presented as depicted in FIG. 7. The Userver application can be programmed to determine whether a called destination has setup a store, and thus return the current stock and location information, to the caller, rather than presenting a generic basic menu of services, as illustrated in the earlier example (FIG. 3 above).

On reading what produce is available, the calling mobile can, select location, and then for example, an option that requests a ‘callback’, whereupon a transaction (more than likely “a trade”) can be verbally negotiated and a rendezvous arranged. Clearly more advanced interaction and services between customer and store owner may be developed. The example simply serves to illustrate how the methods disclosed can deliver essential services, all on leveraging the most basic, rudimentary capability that exists in every network and handset. By adding basic search functionality to the store front, as shown, users may effectively browse the market (not shown).

As the personal information pertaining to the originating and destination mobiles persists between teleservice events, when mobile user 30 is the originating party who is then similarly presented with a USSD menu screen on teleservices destined for mobile user 10, the user is then automatically greeted with the name set for the number they dialed and any service related information they choose to upload. The services are thus rapidly populated, in a viral manner.

In the example above, the information entered may be aggregated and searched as, for example, meta data tags using any and all of the major search providers (for example automatically aggregating Google, Yahoo and MSN Live search results). When selecting the option titled “a<search,” in the above example, the serving application can initiate an Internet search (as a proxy), on the terms supplied returning the most relevant result (not shown). In some implementations, any USSD information returned may be requested to persist on the mobile device (e.g., mobile user 10 device), by, for example, simply selecting an option titled “save as SMS”). The selection could then result in an SMS (MMS, email or other) message being delivered to the mobile user 10 by the USSD serving application that includes the search results. In alternate implementations, the search may result in an automated call back from the provider or from a sponsor.

This market (or “star market”) and virtual store described, delivers what is simply the future perfect digital economy today: a cellular and virtual enterprise of 1, remotely controlled and wirelessly accessible to “n,” on demand. This elementary application can network villages, feed people and transform societies. Especially when one considers that today, lacking the most basic communication services, potential customers may have to travel significant distances (e.g., walk 20 miles on the roundtrip), only to discover that the fish were not available. Similarly, a virtual doctor on call service, can present medical care availability at remotely located clinics, with key press requests for appointments and call backs.

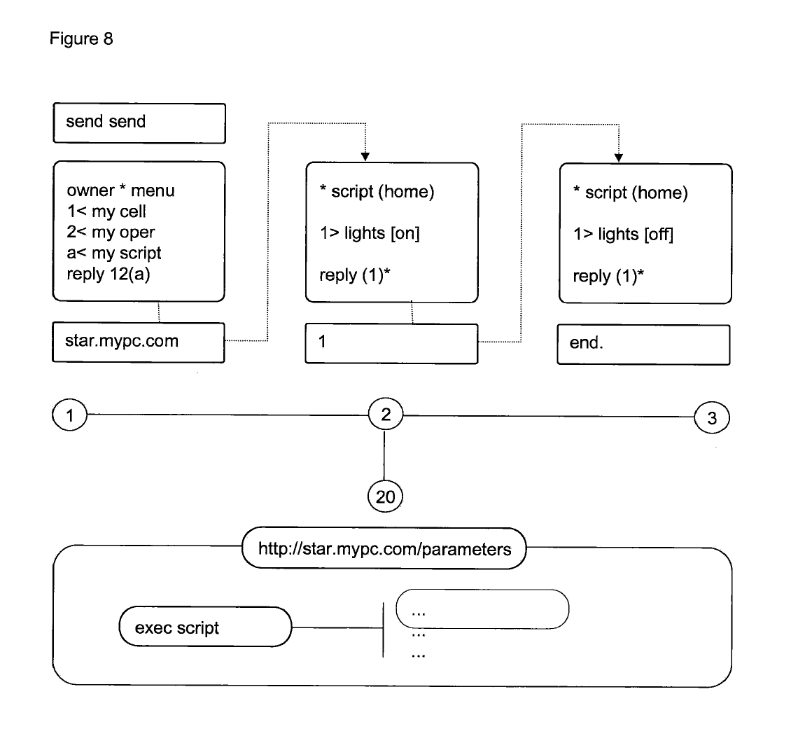

To further illustrate the applicability of the some of the methods disclosed, FIG. 8 depicts another Starlet (“my script”) that enables a mobile user to script and produce their own custom menus, opening a USSD portal to an infinite array of personal and administrative services. These services are remotely executed and securely accessed by the originating mobile, with Userver as a proxy. The salient aspects of this service, is directing the Userver, by associating a URL with the Starlet, to retrieve the text that presents on the mobile screen, and then passing any response received from the mobile, back to the externally executing script. This external link provides a universal hook into a star menu system.

Describing the example service in more detail, on selecting the default option (a<my script) and responding with the URL, the Userver persistently assigns the URL to the “my link” service. When the newly associated “my script” option is selected, the Userver access the URL supplied, proxying the connection. On accessing the supplied URL, the Userver posts “parameter data,” including the source address of the calling mobile. In some implementations, the mobile owner has preprogrammed the script, that executes on the requested URL, to accept data from the Userver according to an open, published protocol, passing as it does basic html scripted text between the two, and performing the appropriate actions required by the mobile owner (i.e., on selecting options from the text served by the URL, that is now displayed “as is” on the mobile display, without any reformatting performed by the Userver). Whereas, the logic that drives the methods and example services illustrated up to now executes under Userver control, in this one instance, the logic and control is performed by the externally reference URL supplied, driving the USSD session remotely.

In this simple example, the script validates that the user requesting access is the owner, by comparing the mobile number passed by the Userver as parameter data, when invoking the externally referenced link. We assume that the user computer referenced by the URL has the necessary circuitry and interfaces at home to monitor and switch appliances on/off, directly from the associated PC. On interrogating, for example that status of the lights in the home, the script returns the preformatted text, which the Userver then returns to the mobile, acting simply as a conduit. The result is screen (2) that is titled “home,” by the serving URL script, and lists a single selection toggle. Any data returned by the remote script, and any response received from the mobile is canonical and transparent to the Userver (except, in some implementations, for one or more special characters such as “*,” which it may intercept), and is simply passed back and forth between the two devices. The remotely executing script, now interprets the input and performs the associated functions.

The method proposed allows for a form of universal remote control. Using these methods, any internet protocol (IP) endpoint, now gains instant wireless functionality, without any wireless infrastructure required, simply on serving ASCII text that is presented to and interacted with by the remote user (i.e., inputting selections on the mobile device). In short order technical administrators can program scripts to present menus that can shut down and restart errant servers, scripts that can ping executing process for realtime performance statistics, which are then instantly displayed, as generated, directly on their mobile devices. One hundred and eighty two characters, the USSD payload, suitably formatted and encoded (e.g., by the script owner, for example, assigning predetermined meaning to special symbols, thereby compacting the data displayed) can result in an almost unlimited amount of information presented. Scripts can be programmed to accept PIN code access, or permit closed user group access (permitting more than one mobile to link), to link outward to other scripts (e.g., to wirelessly unlock vehicles or to remotely switch off the lights in a home).

Examples of the methods disclosed deliver near real time interaction and service differentiation within a regularly established teleservice context, seamlessly, to all phones without change. While these methods are readily applied to delivering managed network services, on the home network, the paradigm lends itself equally to open walled applications. The ability, for example, to seamlessly control services on a peer to peer basis, to switch services on and off, directly between two mobile devices, by engaging interactive menus on the fly, may become increasingly critical, as the mobile phone reaches ubiquity. As more and more less sophisticated users join the mobile community, and as marketers seek to shift advertising from PC to mobile, the ability to control, what is essentially the last private communications channel, becomes paramount.

Examples of the methods disclosed deliver a definitive and simple control plane abstraction to what has become a dauntingly complex communications system. This advanced services wrapper, that is as extensible on the back end, as it is frictionless on the front, succeeds in presenting peer level interaction to users, virtually at their fingertips, in “2clicks,” and in as few seconds.

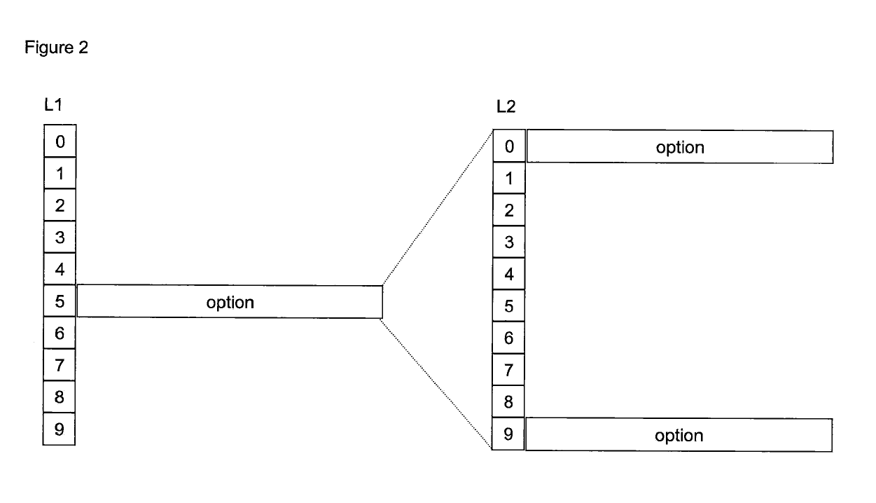

As is evident, given the generic nature of the USSD protocol, a multitude of service options may be created. Pragmatically, to ensure optimum navigation and minimize session hold time, in one implementation services are contained to two levels. As USSD is limited to 182 alphanumeric characters, and given the example methods related to applying numerical enumeration to selection only items, in menus displayed (that is, numbered zero through nine), this simple interface can readily support “one hundred unique services.” An example of such a service matrix, supported by the methods disclosed, is illustrated in FIG. 2.

Further, the methods disclosed lend themselves to delivering a new class of permission based peer-to-peer services, whereby one party can switch access to sensitive and private information on and off, on a cellular level. For example, personal location based information may be made visible to one party and kept hidden from another (delivering virtual “hide n seek”), facilitated by the dynamic scripted nature of the USSD protocol, and the resultant logical assembly of the menu text to be displayed.

In this uniquely applied context, the methods proposed succeed in coupling the USSD session to the caller and called number in the immediately preceding teleservice event. This delivers mass, virtual service differentiation and delivery between caller and called, on the fly. Reverse spawning USSD sessions, from the network side, in the manner disclosed, delivers the harmonic convergence between voice and data interaction, obviating the need to manually switch context and enter commands and codes on the mobile device. As USSD is the only data transport that requires no specific handset and service configuration, whatsoever, and given that nearly every handset supports the Network Initiated Phase 2 protocol, the seamless and discoverable nature of methods disclosed satisfies the metrics governing mass service adoption.

In some implementations, a method is provided for communicating in a mobile network. Responsive to a mobile originating teleservice request, one example method establishes a contextual USSD session with an originating mobile, listing a plurality of network service options associated with the caller and/or the called party address information captured in the teleservice. In some implementations, the USSD session is established by a network initiated push back to the originating mobile device, in concert with the teleservice requested. In some implementations, the USSD session is established by a network initiated push back to the originating mobile device in replacement of the teleservice requested.

In some implementations, the USSD session is established by a device initiated pull, on suitably programmed handsets that automatically modify the request setup characteristics, in concert with the requested teleservice. In some implementations, the USSD session is established by the user selecting a dedicated handset function that transiently applies the appropriate USSD command syntax to augment or replace the requested teleservice request. The dedicated handset function can, for example, be a programmable on screen button or menu item. The dedicated handset function can be selected by suitably modifying an existing physical button, such as the star key or the send key, which then invokes one or more of the methods disclosed. In some implementations the dedicated handset function is programmatically assigned to a new hardware button, e.g., preferably color coded “orange” and labeled “@.”

In some implementations, it is envisaged that once the disclosed interactive USSD menu service becomes widely adopted, the service can be embedded in a mobile device itself (i.e., not requiring a complete server side implementation). This would allow a shift of the invocation from being network pushed to being either network pushed or handset pulled. In these implementations, the methods disclosed could be established from the originating device by, for example, programming new functionality to capture the teleservice request prior to transmitting it over the air interface towards the network. In some implementations, the capture functionality is implemented using well-known development tools and techniques, including downloadable Java Applets, and over the air deployed, SIM Toolkit Applications.

In some implementations, the originating device monitors originating teleservice events directly on the mobile device, and modifies the setup characteristics to request the USSD session in concert with the teleservice by, for example, issuing an additional USSD service request in parallel to the original teleservice request. In some implementations, the modification can be achieved by applying the requisite codes to the destination address captured in the original teleservice request. In this example configuration, the handset so enabled can automatically issue the following command:

*111*4154125111# send

In the above example, the USSD application code prefix (“111”), may be provisioned directly with the home network operator in advance, in order to route the request toward the associated Userver (USSD application server). However, if the applied prefix code is not provisioned on the home network, any Network may be configured to automatically route what would then be an “undefined code,” to a default USSD application that would then present the contextual menu as disclosed. This “wild card” routing, of all undefined USSD codes, overcomes the “chicken and egg” problem that presents when attempting to develop a uniform application capable of operating transparently on multiple networks.

In some implementations, the suitably modified device intercepts and replaces the originating Teleservice event, directly on the handset by, for example, modifying the setup characteristics to invoke the USSD session as detailed above, in response to an explicit feature selection by the user. For example, on addressing the original teleservice request, the user can press and hold the “Send key,” which then modifies the request, to request the interactive USSD menu rather, than the conventional teleservice. Similarly, in one example implementation, a third orange color (“shift”) signaling key, complimenting the standard Green (go) and Red (stop) functionality, could initiate the interactive USSD session directly, by applying the modification to a selected contact or telephone number on the display.

Equivalent interactive USSD menu service functionality may be delivered, for example; by a Java applet that presents the resident phone book with the new capability (e.g., menu delivery) as the desired service provided. Here, the user could select a destination phone number, and press “send” (connect) to request USSD menu interaction as disclosed, rather than connect and talk to party which is the conventional function. Importantly, the USSD session is once again established seamlessly, in that the user is not required to enter the command directly. While the challenge to modifying existing handset functionality is non trivial, the advantage to pushing the USSD request from the handset is twofold.

First, since the request originates from the mobile device, presenting the request to the network does not require the network to page and locate the mobile on returning the initial USSD menu this advantage may be offset, somewhat by the fact that where the network initiates the USSD session, the USSD message is pushed to the originating handset within a very small delta time frame, from receiving the original teleservice request. Further, network paging and routing optimizations may yield caching benefits, in that the originating mobile location would be unchanged and thus already known to the network. Second, when the originating mobile roams onto a foreign, visited network, the USSD request issued from the handset is routed via the home network HLR, delivering the same service capability to the roaming customer. Again whilst this is a benefit, the overwhelming masses never roam outside the home network.

Other modifications, features, and embodiments of the present invention will become evident to those of skill in the art. It should be appreciated, therefore, that many aspects of the present invention were described above, by way of example only and are not intended as required, or essential elements; of the invention unless explicitly stated otherwise. For example, sessions and menus may incorporate additional information, services, sponsorships, promotions and advertisements, provided by the network and/or by third parties, and these said services mayor may not require explicit selection and interaction. In addition, sessions and menus may similarly be established with the called party, either singularly or in concert with the exemplary methods disclosed (which illustrate menus established with the calling party).

Further, while USSD has uniquely qualifying characteristics suited to mass market service deployment (including being both the bearer and the presentation layer, being control plane signaled, session based, virtual, realtime and scripted, and being universally adopted and free from “end user administration,” requiring neither handset configuration nor service subscription) other well known data bearers, transports and presentation layers may be similarly utilized.

Methods proposed may be executed by one or more processors, computers, or devices. Methods may be embodied in computer readable medium and include instructions for causing a processor to execute steps associated with the described methods. It should be understood that the foregoing relates only to certain embodiments of the invention and that numerous changes may be made therein without departing from the spirit and scope of the invention as defined by the following claims and the disclosed embodiments. It should also be understood that the invention is not restricted to the illustrated embodiments and that various modifications can be made within the scope of the following claims.

What is claimed is:

1. A method comprising:
responsive to a mobile originated teleservice request, pushing a contextual network initiated Unstructured Supplementary Services Data (USSD) session back to an originating mobile device including presenting a listing of a plurality of service options associated with a caller and/or the called party address information captured in the teleservice request.

2. The method according to claim 1, where the teleservice request is a mobile telephony request, and where pushing includes presenting a menu of interactive services and transactions, in concert with a call, which the caller may then disconnect at their discretion.

3. The method according to claim 2, where the mobile telephony request is intentionally disconnected by the caller during call setup and where pushing includes presenting a menu of interactive services and transactions to the caller, without ringing the destination.

4. The method according to claim 2, where the mobile telephony request is suspended by the network during setup on determining that the caller is roaming, and where pushing includes presenting a menu of alternate billing and third party services to the caller, prior to resuming call processing.

5. The method according to claim 2, where the mobile telephony request is disconnected by the network during setup on determining that the caller has insufficient credit to complete the call, and pushing includes presenting a menu of billing and third party services to the caller.

6. The method according to claim 2, where the mobile telephony request is disconnected by the network on determining that the network is congested and that there are insufficient resources to complete the request, and where pushing includes presenting a menu of alternate and emergency services to the caller.

7. The method according to claim 1, where the teleservice request is a mobile originated short message, where the message content adheres to a specific format, and pushing includes presenting a menu of related services without necessarily delivering the original message to the recipient.

8. The method according to claim 7, where the originated short message has no content, and pushing includes presenting a menu of interactive services and transactions to the caller, without necessarily delivering the empty message to the recipient.

9. A method comprising
responsive to a mobile originated teleservice request, programmatically establishing a contextual Unstructured Supplementary Services Data (USSD) session between the originating device and the servicing network including presenting a menu listing a plurality of service options associated with a caller and/or the called party address information captured in the teleservice request.

10. The method according to claim 9, where the teleservice requested is a mobile telephony connection, and where the network initiates the USSD session, pushing it back to an originating mobile, presenting a menu of interactive services and transactions in concert with a telephony call, either which the caller may then dismiss with discretion.

11. The method according to claim 10, where the mobile telephony request is intentionally cancelled by the caller during call setup, and where pushing includes presenting a menu of interactive services and transactions to the caller without ringing the destination.

12. The method according to claim 10, where the mobile telephony request is suspended by the network during setup on determining that the caller is roaming, and where pushing includes presenting a menu of alternate billing and third party services to the caller prior to resuming call processing.

13. The method according to claim 10, where the mobile telephony request is disconnected by the network during setup, on determining that the caller has insufficient credit to complete the call, and pushing includes presenting a menu of basic managed services to the caller.

14. The method according to claim 10, where the mobile telephony request is disconnected by the network on determining that the network is congested and that there are consequently insufficient resources to complete the request, and where pushing includes presenting a menu of alternate and emergency services to the caller.

15. The method according to claim 10, where the mobile telephony request is disconnected by the network on determining that the destination device is unavailable, and where pushing includes presenting a menu of alternate communication services to the caller.

16. The method according to claim 9, where the teleservice request is a mobile originated short message submission, and on detecting a predetermined pattern in the short message body, the network pushing the USSD session back to the sender, which includes presenting a menu of related services without necessarily delivering the original message to the recipient.

17. The method according to claim 16, where the originated short message has no content, and pushing includes presenting a menu of predetermined interactive services and transactions to the caller without necessarily delivering the empty message to the recipient.

18. The method according to claim 9, where the teleservice requested is intercepted by monitoring software installed on the mobile device and/or SIM card prior to being transmitted towards the network, and where the monitoring application assembles and requests the USSD session in concert with or in replacement of the teleservice requested.

19. The method according to claim 18, where the teleservice is a mobile telephony request, and the monitoring software initiating the USSD session on detecting a disconnect issued by the caller, or the network, during the call setup phase.

20. The method according to claim 18, where the teleservice is a mobile telephony request, and the monitoring software initiating the USSD session on detecting a network busy signal and requesting a menu of alternate services.
